(19) United States
(12) Patent Application Publication
(10) Pub. No.: US 2024/0314098 A1
(43) Pub. Date: Sep. 19, 2024

(54) MAINTAINING A MESSAGE THREAD WITH OPT-IN PERMANENCE FOR ENTRIES

(71) Applicant: Snap Inc., Santa Monica, CA (US)

(72) Inventors: Evan Spiegel, Los Angeles, CA (US); Timothy Sehn, Marina Del Rey, CA (US)

(21) Appl. No.: 18/674,419

(22) Filed: May 24, 2024

Related U.S. Application Data
(63) Continuation of application No. 17/970,003, filed on Oct. 20, 2022, now Pat. No. 12,034,690.
Application No. 17/970,003 is a continuation of application No. 17/402,316, filed on Aug. 13, 2021, now Pat. No. 11,509,618.
Application No. 17/402,316 is a continuation of application No. 16/552,018, filed on Aug. 27, 2019, now Pat. No. 11,134,046.
Application No. 16/552,018 is a continuation of application No. 15/682,404, filed on Aug. 21, 2017, now Pat. No. 10,439,972.
Application No. 15/682,404 is a continuation of application No. 14/274,610, filed on May 9, 2014, now Pat. No. 9,742,713.
Application No. 14/274,610 is a continuation-in-part of application No. 13/906,261, filed on May 30, 2013, now Pat. No. 9,705,831.

(51) Int. Cl. H04L 51/216

(52) U.S. Cl. CPC H04L 51/216

(57) ABSTRACT

A server has a processor and a memory storing a message thread module with instructions executed by the processor to maintain a message thread between users of client devices. The message thread module serves a message thread with a new text entry to a client device in response to a request for the message thread from a user. Message thread state change is collected from the client device, where the message thread state change represents an indication to automatically delete the new text entry of the message thread after the duration of a transitory display period on the client device unless an indication of a gesture applied to a display screen presenting the new text entry of the message thread is received from the client device during the transitory display period. The message thread state change is queued at the server along with additional message thread state changes associated with the collecting operation performed for additional users associated with the message thread. The message thread is revised based upon the message thread state change and the additional message thread state changes to form shared message thread state. The shared message thread state is stored. The shared message thread state is supplied in response to a request for the message thread from a user.

### CROSS-REFERENCE TO RELATED APPLICATIONS

This application is a continuation of U.S. patent application Ser. No. 17/970,003, filed Oct. 20, 2022, which is a continuation of U.S. patent application Ser. No. 17/402,316, filed Aug. 13, 2021, which is a continuation U.S. patent application Ser. No. 16/552,018, filed Aug. 27, 2019, which is a continuation of U.S. patent application Ser. No. 15/682,404, filed Aug. 21, 2017, which is a continuation of U.S. patent application Ser. No. 14/274,610, filed May 9, 2014, which is a continuation-in-part of U.S. patent application Ser. No. 13/906,261, filed May 30, 2013, each of which are incorporated herein by reference in their entireties.

### FIELD OF INVENTION

This invention relates generally to communications in a networked environment. More particularly, this invention relates to maintaining a message thread with opt-in permanence for entries.

### BACKGROUND OF THE INVENTION

Communications between individuals are increasingly digitized and transmitted via the Internet. Individuals are communicating through text messages, email messages, voice mail messages and the like. In the case of a text message between two individuals a conversation thread is maintained. Each individual contributes text to a chronologically listed record of the communications between the two individuals. With each new communication, a new entry is added to the communication thread. Either individual can review the conversation thread at any time and edit it locally in the messaging client.

Maintaining a complete and precise record of a sequence of communication may inhibit the spontaneity of an interaction. For example, when one has a conversation with an individual, it is typically not recorded and therefore the exchange may be more candid.

A live conversation between two individuals may be memorialized with notes, but in this case there is visual feedback indicating when one individual is recording information, which allows the other individual to clarify a point or otherwise alter the direction of the conversation.

Storing the entire contents of a digital conversation may also make it difficult to surface the most important information. It is a case of information overload. Selectively saving certain communications in an ephemeral conversation thread allows the user to quickly recall or reference important aspects of the thread.

In view of the foregoing, it would be desirable to have a digital communication mechanism that more naturally mimics the types of interactions to which individuals are accustomed.

### SUMMARY OF THE INVENTION

A server has a processor and a memory storing a message thread module with instructions executed by the processor to maintain a message thread between users of client devices. The message thread module serves a message thread with a new text entry to a client device in response to a request for the message thread from a user. Message thread state change is collected from the client device, where the message thread state change represents an indication to automatically delete the new text entry of the message thread after the duration of a transitory display period on the client device unless an indication of a gesture applied to a display screen presenting the new text entry of the message thread is received from the client device during the transitory display period. The message thread state change is queued at the server along with additional message thread state changes associated with the collecting operation performed for additional users associated with the message thread. The message thread is revised based upon the message thread state change and the additional message thread state changes to form a single shared message thread state. The shared message thread state is stored. The single shared message thread state is supplied in response to a request for the message thread from a user.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates message generation processing utilized in accordance with an embodiment of the invention.

FIG. 3 illustrates message consumption processing utilized in accordance with an embodiment of the invention.

FIG. 4 illustrates message thread review processing utilized in accordance with an embodiment of the invention.

FIG. 5 illustrates a first message thread displayed in accordance with an embodiment of the invention.

FIG. 6 illustrates the message thread of FIG. 5 with altered parameters associated with entries of the message thread.

FIG. 7 illustrates asynchronous batch mode processing performed in accordance with an embodiment of the invention.

Like reference numerals refer to corresponding parts throughout the several views of the drawings.

### DETAILED DESCRIPTION OF THE INVENTION

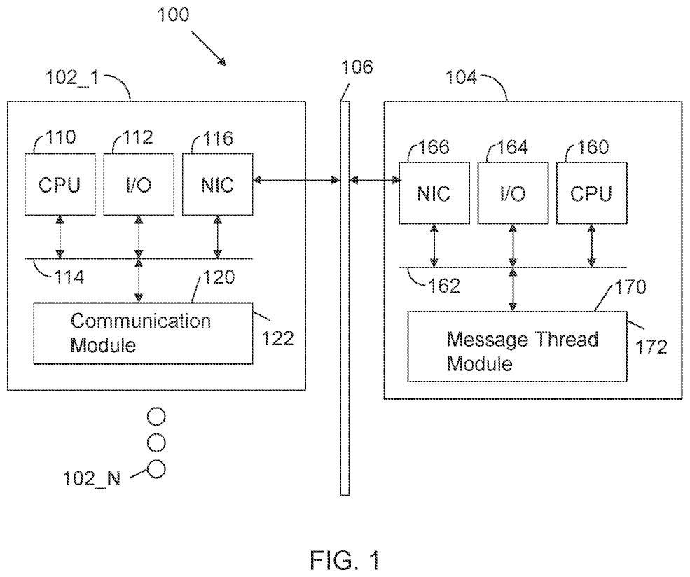

FIG. 1 illustrates a system 100 configured in accordance with an embodiment of the invention. The system 100 includes a set of client devices 102_1 through 102_N and at least one server 104 connected via a network 106, which may be any wired or wireless network.

Each client device 102 may be a computer, tablet, Smartphone and the like with standard components, such as a central processing unit 110 connected to input/output devices 112 via a bus 114. The input/output devices 112 may include a touch display, keyboard, mouse and the like. A network interface circuit 116 is also connected to the bus 114 to provide connectivity with network 106.

A memory 120 is also connected to the bus 114. The memory 120 stores standard components, such as a communication module 122. The communication module 122 may be a text message module that supports ShortMessage Service (SMS) texting. Alternately, the communication module 122 may be a browser, which supports access to an email server. Alternately, the communication-module 122 may be a telephony interface that supports telephone interactions, such as voice messages.

Server 104 also includes standard components, such as a central processing unit 160 connected to input/output devices 164 via a bus 162. A network interface circuit 166 is also connected to the bus 162. Further, a memory 170 is connected to the bus 162. The memory 170 stores modules of executable instructions to implement disclosed operations. For example, the memory 170 may store a message thread module 172, which maintains a thread of communications between at least two individuals. The thread of communications may be a text message thread, an email with a sequence of returned communications or a voice mail file with a sequence of returned communications.

The configuration of system 100 is exemplary. The system 100 may include multiple servers 104 and a variety of communication devices to support various forms of digital communication.

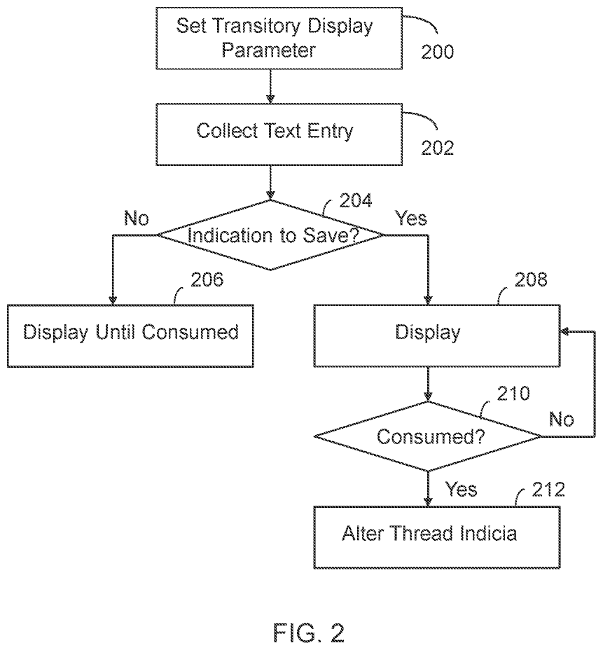

FIG. 2 illustrates processing operations associated with an embodiment of the message thread module 172. In particular, the figure illustrates message generation processing utilized in accordance with an embodiment of the invention. By way of example, operations will be discussed in the context of text messaging.

Initially, a transitory display parameter is set 200. The transitory display parameter may be set as a default value (e.g., a 3 second viewing period) or it may be set through user input. The notion associated with the transitory display parameter is that all message entries will be deleted after the transitory display parameter time expires and therefore message entries are transitory, unless an individual opts-in for message entry permanence.

The next operation of FIG. 2 is to collect a text entry 202. The text entry collection process is terminated when an individual indicts that the text entry should be sent. At this point it is determined if there was an indication to save the text entry 204. The indication may be in the form of a gesture applied to the screen where the text is entered. Alternately, the indication may be based upon a specified key or combination of keys on a keyboard used to enter the text.

If there is no indication to save the entry (204-No), then the text is displayed in the thread associated with the sender and the recipient. When the recipient reads or otherwise consumes the entry, the entry is deleted from the thread associated with the sender 206.

If there is an indication to save the entry (204-Yes), then the entry is displayed in its original form in the thread associated with the sender and the recipient. A check is periodically made to determine if the entry has been read by the recipient 210. If not (210-No), the entry continues to be displayed in its original form. If so (210-Yes), indicia associated with the thread is altered 212. That is, after the recipient reads the entry the nature of the entry will be altered on the sending side and the receiving side. If the recipient does not provide an indication to save the entry, then the indicia of the entry on the sending side thread will be altered to indicate that only one of the two parties (the sender) has saved the entry. If the recipient provides an indication to save the entry, then the indicia of the entry on the sending side and the receiving side is altered to indicate that both of the parties have saved the entry. In an alternate embodiment, the message may be restored in the sender side thread if the recipient provides an indication to save the message. This restoration in the sender side thread includes indicia that the recipient saved the message, although the sender originally declined to do so.

The operations of FIG. 2 are performed by the message thread module 172 operating in conjunction with a client device 102. That is, operations such as collecting a text entry 202 and identifying an indication to save 204 are performed at the client device 102, with the results of the operations passed and processed to the message thread module 172. Similarly, the display until consumed operation 206, display operation 208 and altering of thread indicia 212 are manifested at the client device 102 in response to information supplied by the message thread module 172.

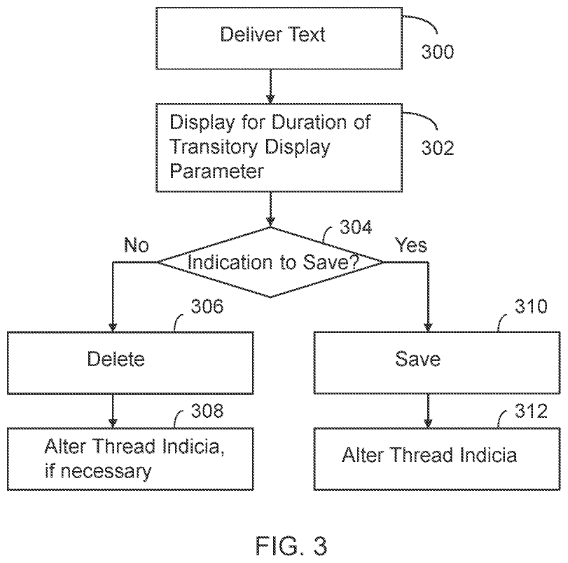

FIG. 3 illustrates message consumption processing operations performed in accordance with an embodiment of the invention. The message thread module 127 coordinates the delivery of the text to the recipient 300. The text is displayed for the duration of the transitory display parameter 302. That is, the message thread module 127 directs the client device 102 to display the text for the duration of the transitory display parameter. Alternately, the text may be displayed until it is actively deleted or the user scrolls past it without saving it.

It is determined whether there is an indication to save the entry 304 during the duration of the transitory display parameter. If not (304-No), the message is deleted 306 from the recipient's thread. Thread indicia of the sender is altered, if necessary 308. That is, if the sender elected to preserve the entry, then indicia associated with the entry would be altered to indicate that the sender preserved the entry, but the recipient did not.

If there is an indication to save the entry (304-Yes), the entry is saved in the recipient's thread 310. The thread indicia are altered 312 to at least indicate that the recipient has saved the entry. If the sender also saved the entry, then the sender's indicia and the recipient's indicia reflect that both entities have saved the message.

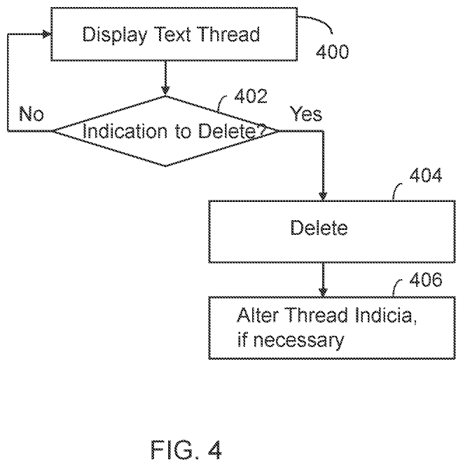

FIG. 4 illustrates thread review processing that may be performed in accordance with an embodiment of the invention. Initially, a text thread is displayed to a user 400. The text thread is between the user and one or more other users. As the user scrolls through the text thread, individual entries may be deleted. If so (402-Yes), the individual entry is deleted 404. If necessary, indicia associated with the entry on another device is altered 406. For example, if another user had saved the entry and the present user had saved the entry initially, then the indicia associated with the entry on the two client devices would indicate that both parties saved the entry. After one party deletes the entry, the indicia associated with the entry for the other party indicates that only a single party has saved the entry.

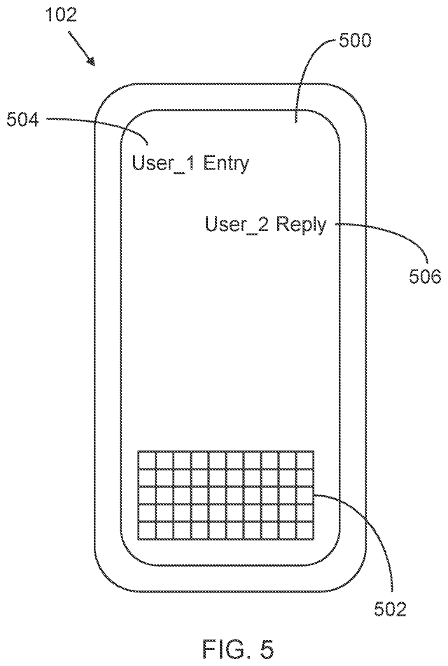

FIG. 5 illustrates a client device 102 with a display screen 500 and a keyboard 502. The display screen 500 displays a thread including a first entry 504 from a first user and a second entry 506 from a second user. The first entry 504 is persisted in response to a gesture applied to the display screen 500. The second entry 506 is also persisted in response to a gesture applied to the display screen 500.

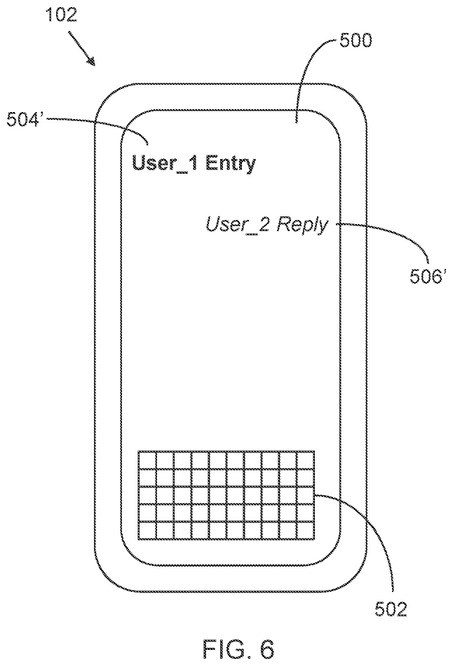

FIG. 6 illustrates updated indicia indicating different states of entry preservation. Entry 504′ is in bold to reflect that both the sender and the recipient persisted the entry. Entry 506′ is italicized to indicate that the reply was preserved by the recipient, but not the sender.

Thus, in this example, a parameter in the form of varying fonts is altered to reflect the persistence of an entry. Other parameters may be used, such as a separate graphic indicative of the preservation states. Alternately, the parameter may be in the form of a number where a 1 indicates that only the user of the client device has saved the entry and where the number 2 indicates that two parties have saved the entry. Larger numbers may be used in the event of a group message. A text color scheme may also be used to indicate preservation states.

In one embodiment, the message thread module 172 is configured to eliminate the ability to copy/paste a conversation? This prevents aspects of the conversation from being taken out of context. In addition, this feature keeps the record of the “saved” communications consistent.

Thus, it will be appreciated that the disclosed techniques allow for a digital communication mechanism that more naturally mimics the types of interactions to which individuals are accustomed. That is, individual utterances (entries) are transitory in nature, unless a user opts-in to preserve an utterance. Opting-in to preserve an utterance may result in feedback that allows a counter-party to know that another has preserved the entry.

In addition to providing a more natural communication flow, the invention may provide a more condensed communication thread where only perceived important entries are preserved. This can be advantageous in connection with the use of a mobile device, which has a small screen and therefore a limited ability to display information. This may also be advantageous as it reduces the amount of information that needs to be communicated across a network.

The invention has been disclosed in the context of text communications. However, the same techniques may be applied to email communications or threaded voicemail or multimedia communications.

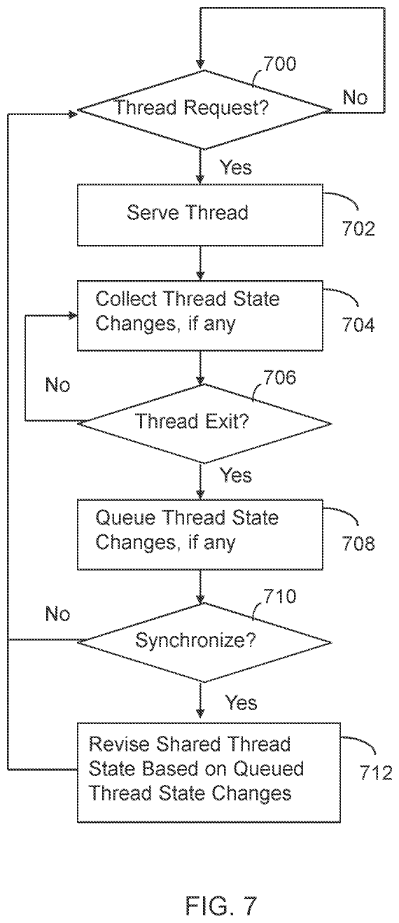

This disclosure has discussed real time updates to a message thread. An embodiment of the invention reduces computation demand by utilizing batch mode asynchronous processing. The message thread module 172 may be configured to implement such operations, as shown in FIG. 7. Initially, a request for a message thread is received 700. The message thread is associated with two or more users, any of which may request the message thread. The request is typically in response to an indication of a new text entry in the message thread. The message thread is served 702. Message thread state change, if any, is collected 704. The message thread state change represents an indication to automatically delete the new text entry of the message thread after the duration of a transitory display period on the client device unless an indication of a gesture applied to a display screen presenting the new text entry is received from the client device during the transitory display period. The state change may be queued at the server instantaneously or when the user exits the message thread (706-Yes). State changes, if any, are queued by the server 708. It should be appreciated that the queued messages may include message thread state change from the recently served message thread and/or additional message thread state changes from previously and subsequently served message threads to other users associated with the message thread.

A synchronization condition may then be applied 710. The synchronization condition may be a specified time of day. For example, batch mode asynchronous processing may be performed in the middle of the night when there is typically low demand on computational resources. If the synchronization condition is satisfied (710-Yes), the shared thread state is revised based on queued thread state changes 712. That is, the message thread is revised based upon all message thread state change associated with the message thread to produce new shared message thread state, which may be persistently stored until the next synchronization event. The new shared message thread state is supplied 702 in response to a request for the message thread from a user (700-Yes).

Techniques of the invention may be used in connection with non-textual communications, such as a thread of exchanged photographs. Further, the techniques of the invention may be used in connection with a variety of user inputs, such as a mouse click associated with a desktop computer, a gesture applied to a controller associated with a game console, a shaking motion applied to a mobile device and the like.

An embodiment of the present invention relates to a computer storage product with a non-transitory computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media, optical media, magneto-optical media and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

What is claimed is:

1. A method comprising:
responsive to determining that a request to preserve one or more content items has been received, modifying, by one or more processors, a display attribute of textual content based on a quantity of users in a set of users from which the request to preserve was received; and
incrementing a displayed value each time a request to preserve the one or more content items is received from the set of users.

2. The method of claim 1, further comprising:
receiving, from a first device, the one or more content items exchanged in a communication session, the textual content being displayed by the first device according to a given display attribute, wherein as a result of modifying the display attribute, the textual content being displayed by the first device changes from being displayed according to the given display attribute to being displayed according to a different display attribute.

3. The method of claim 2, wherein the one or more content items are directed to a second device, further comprising:
displaying the one or more content items by the second device;
determining that the request to preserve the one or more content items was received from (1) either the first device or the second device or (2) from both the first and second devices;
modifying the given display attribute according to which of the one or more content items are being displayed by the second device in a first manner, in response to determining that the request to preserve the one or more content items is received from either the first device or the second device; and
modifying the given display attribute according to which of the one or more content items are being displayed by the second device in a second manner, in response to determining that the request to preserve the one or more content items is received from both the first and second devices.

4. The method of claim 2, further comprising:
receiving from the first device the request to preserve the one or more content items, wherein the request to preserve the one or more content items is received from the first device in response to a first gesture applied to a first display screen of the first device.

5. The method of claim 1, further comprising automatically deleting the one or more content items displayed by a second device after duration of a display period unless the request to preserve the one or more content items is received from the second device during the display period.

6. The method of claim 5, further comprising:
receiving the request to preserve the one or more content items from the second device during the display period; and
in response to receiving the request to preserve the one or more content items:
generating an altered text indicia;
maintaining the one or more content items displayed on the second device with the altered text indicia; and
providing feedback to a first device indicating that the request to preserve the one or more content items was received from the second device.

7. The method of claim 1, wherein the textual content includes a first textual entry and a second textual entry, further comprising:
causing a first device to display simultaneously the first and second textual entries with different display attributes, wherein the first textual entry is displayed with a given display attribute modified in a first manner to indicate that the request to preserve the one or more content items was received from either the first device or a second device, and wherein the second textual entry is displayed with the given display attribute modified in a second manner to indicate that the request to preserve the one or more content items was received from both the first and second devices.

8. The method of claim 7, wherein the first textual entry was received from the first device and the second textual entry was received from the second device.

9. The method of claim 1, further comprising providing first indicia indicating that only a first device requested to preserve the one or more content items and that there was no request to preserve the one or more content items received from a second device.

10. The method of claim 9, further comprising providing a second indicia to indicate that both the first device and the second device requested to preserve the one or more content items.

11. The method of claim 1, wherein modifying the display attribute comprises italicizing text included in the one or more content items.

12. The method of claim 1, wherein modifying the display attribute comprises displaying text included in the one or more content items in bold.

13. The method of claim 1, wherein modifying the display attribute comprises presenting text included in the one or more content items in a first color or with a first number.

14. The method of claim 1, further comprising preventing a portion of the set of users from performing a copy/paste operation in relation to the one or more content items.

15. The method of claim 1, wherein the one or more content items are presented at a same time on both a first device and a second device.

16. The method of claim 1, wherein the one or more content items comprise a text communication, email communication, voicemail communication, or multimedia communication.

17. The method of claim 1, wherein the one or more content items are part of a content item thread among a plurality of users.

18. The method of claim 1, further comprising automatically deleting the one or more content items when a user scrolls past the one or more content items without requesting to preserve the one or more content items.

19. A system comprising:
one or more processors configured to perform operations comprising:
responsive to determining that a request to preserve one or more content items has been received, modifying a display attribute of textual content based on a quantity of users in a set of users from which the request to preserve was received; and
incrementing a displayed value each time a request to preserve the one or more content items is received from the set of users.

20. A non-transitory computer readable medium comprising non-transitory computer readable instructions that, when executed by one or more processors, perform operations comprising:
responsive to determining that a request to preserve one or more content items has been received, modifying a display attribute of textual content based on a quantity of users in a set of users from which the request to preserve was received; and
incrementing a displayed value each time a request to preserve the one or more content items is received from the set of users.
